(19) United States
(12) Patent Application Publication
(10) Pub. No.: US 2015/0222037 A1
(43) Pub. Date: Aug. 6, 2015

(54) HIGH RELIABILITY INTERCONNECT FOR CONDUCTIVE INK CIRCUITS

(71) Applicant: Miraco, Inc., Manchester, NH (US)

(72) Inventors: DOUGLAS BULMER, Windham, NH (US); Jonathan Roberts, Canaan, NH (US)

(21) Appl. No.: 14/540,739

(22) Filed: Nov. 13, 2014

Related U.S. Application Data
(60) Provisional application No. 61/934,268, filed on Jan. 31, 2014.

(51) Int. Cl. H01R 13/11; H01R 13/627; H01R 43/00

(52) U.S. Cl. CPC H01R 13/11; H01R 43/00; H01R 13/627

(57) ABSTRACT

The system and method of electrically interconnecting conductive ink circuits with other electrical components such as wire harnesses, circuit boards, and flexible printed circuits. The rolling, contact system does not damage or degrade the conductive ink surface, which makes it suitable for a high number of insertion/extraction cycles. The system and method features a spring-loaded contact system that is specifically designed for a high number of mating cycles that incorporates one or more rolling conductive elements used to electrically contact a multi-conductor circuit.

### CROSS REFERENCE TO RELATED APPLICATIONS

This Application claims the benefit of U.S. Provisional Application No. 61/934,268, filed Jan. 31, 2014, the contents of which are incorporated by reference herein in their entirety.

### FIELD OF INVENTION

The present invention relates to the field of single or multiple conductor printed ink circuits and electrical connectors used for interconnecting said circuits with other electrical devices and more particularly to a rolling element that is used to make an electrical contact between a printed circuit and a spring loaded contact.

### SUMMARY OF THE INVENTION

One aspect of the present invention is An electrical interconnection system, comprising a spring-loaded contact comprising an electrically conductive material; and one or more conductive rolling elements.

One embodiment of the present invention is wherein there are two or more conductive rolling elements.

One embodiment of the present invention is wherein the two or more conductive rolling elements are positioned to create a double-ended female connector.

One embodiment of the present invention is wherein the one or more conductive rolling elements are cylindrical.

One embodiment of the present invention is wherein the one or more conductive rolling elements are spherical.

One embodiment of the present invention is wherein the one or more conductive rolling elements are retained by the spring-loaded contact.

One embodiment of the present invention is wherein the one or more conductive rolling elements are in electrical contact with the spring-loaded contact.

One embodiment of the present invention further comprises an electrically insulated housing retaining one or more electrically conductive spring-loaded contacts comprising one or more conductive roiling elements.

One embodiment of the present invention further comprises a single or multi-conductor circuit.

One embodiment of the present invention is wherein the electrically insulated housing positions a single or multi-conductor circuit in electrical contact with the one or more electrically conductive spring-loaded contacts comprising one or more conductive rolling elements during a mating cycle.

One embodiment of the present invention is wherein the electrically insulated housing further comprises a friction lock to retain a single or multi-conductor circuit in electrical contact with the one or more electrically conductive spring-loaded contacts comprising one or more conductive rolling elements during a mating cycle.

One embodiment of the present invention is wherein the friction lock is comprised of spring loaded locking elements comprising rolling elements.

One embodiment of the present invention is wherein the electrically insulated housing further comprises a releasable mechanical lock to retain a single or multi-conductor circuit in electrical contact with the one or more electrically conductive spring-loaded contacts comprising one or more conductive rolling elements during a mating cycle.

One embodiment of the present invention further comprises an electrically insulated housing retaining a single or multi-conductor circuit that is mateable with the electrically insulated housing retaining the one or more electrically conductive spring-loaded contacts comprising one or more conductive rolling elements.

Another aspect of the present invention is a method of manufacturing an electrical interconnection system comprising one or more spring-loaded contacts and one or more conductive rolling elements, comprising providing one or more conductive rolling elements; providing one or more spring loaded contacts; and contacting the one or more conductive rolling elements with the one or more spring-loaded contacts.

One embodiment of the present invention is wherein the step of contacting comprises retaining the rolling element in the spring-loaded contact.

One embodiment of the present invention is wherein the step of contacting comprises retaining the rolling element in the housing.

One embodiment of the present invention is wherein the spring-loaded contact is stamped, formed, etched, or coined to retain the conductive rolling element.

These aspects of the invention are not meant to be exclusive, and other features, aspects, and advantages of the present invention will be readily apparent to those of ordinary skill in the art when read in conjunction with the following description, appended claims, and accompanying drawings.

### BRIEF DESCRIPTION OF THE DRAWINGS

The foregoing and other objects, features, and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIGS. 1A-1C show prior art disposable sensors.

FIG. 2 shows prior art AMPMODU interconnection systems.

FIG. 3 shows one embodiment of a multiple conductor printed ink circuit of the present invention.

FIG. 4 shows one embodiment of a housing of the present invention in an open configuration that is used to retain a multiple conductor primed ink circuit as shown in FIG.

FIG. 5 shows one embodiment of a housing of the present invention in a closed configuration that is used to retain a multiple conductor printed ink circuit as shown in FIG. 3.

FIG. 6 shows one embodiment of a spring-loaded contact of the present invention comprising a rolling element.

FIG. 7 shows one embodiment of a housing of the present invention in an open configuration that is used to position and retain a spring-loaded contact of the present invention comprising a rolling element as Shown in FIG. 6.

FIG. 8 shows one embodiment of a housing of the present invention in a closed configuration that is used to position and retain a spring-loaded contact of the present invention comprising a rolling element as shown in FIG. 6.

FIG. 9 shows one embodiment of a housing of the present invention with wire (strain relief) protectors that is used to retain a spring-loaded contact of the present invention.

FIG. 10 shows a front perspective view of a housing of the present invention that is used to retain a spring-loaded contact of the present invention comprising a rolling element as shown in FIG. 9.

FIG. 11 represents a perspective view of certain embodiments of the present invention that are mateable; the embodiments are as shown in FIG. 5 and FIG. 9.

FIG. 12 represents a top view of certain embodiments of the present invention that are mateable; the embodiments are as shown in FIG. 5 and FIG. 9.

FIG. 13 represents a cut-away perspective view of certain embodiments of the present invention that are mated; the embodiments are as shown in FIG. 5 and FIG. 9.

FIG. 14 shows a deconstructed side view of a spring-loaded contact of the present invention comprising a rolling element and a multiple conductor circuit in an electrically insulted housing.

FIG. 15 shows an embodiment of a spring-loaded contact comprising a rolling element of the present invention.

FIG. 16 shows an embodiment of a spring-loaded contact comprising a rolling element of the present invention.

FIG. 17 shows an embodiment of a spring-loaded contact comprising a rolling element of the present invention.

FIGS. 18A-18D show an embodiment of a spring-loaded contact comprising a rolling element of the present invention.

FIGS. 19A-19D show an embodiment of a spring-loaded contact comprising a rolling element of the present invention.

FIGS. 20A-20D show an embodiment of a spring-loaded contact comprising a rolling element of the present invention.

FIGS. 21A-21D show an embodiment of a spring-loaded contact comprising a rolling element of the present invention.

FIGS. 22A-22D show an embodiment of a spring-loaded contact comprising a rolling element of the present invention.

FIGS. 23A-23D show an embodiment of a spring-loaded contact comprising a rolling element of the present invention.

FIGS. 24A-24D show an embodiment of a spring-loaded contact comprising a rolling element of the present invention.

### DETAILED DESCRIPTION OF THE INVENTION

Currently, there is a growing market for disposable medical sensors that are constructed using conductive printed ink circuit technology. These sensors are used in a variety of applications such as blood glucose detection, EKG/ECG sensing, pulse oximetry sensing, and the like. Conductive ink sensors are desired, in part, for their low manufacturing cost.

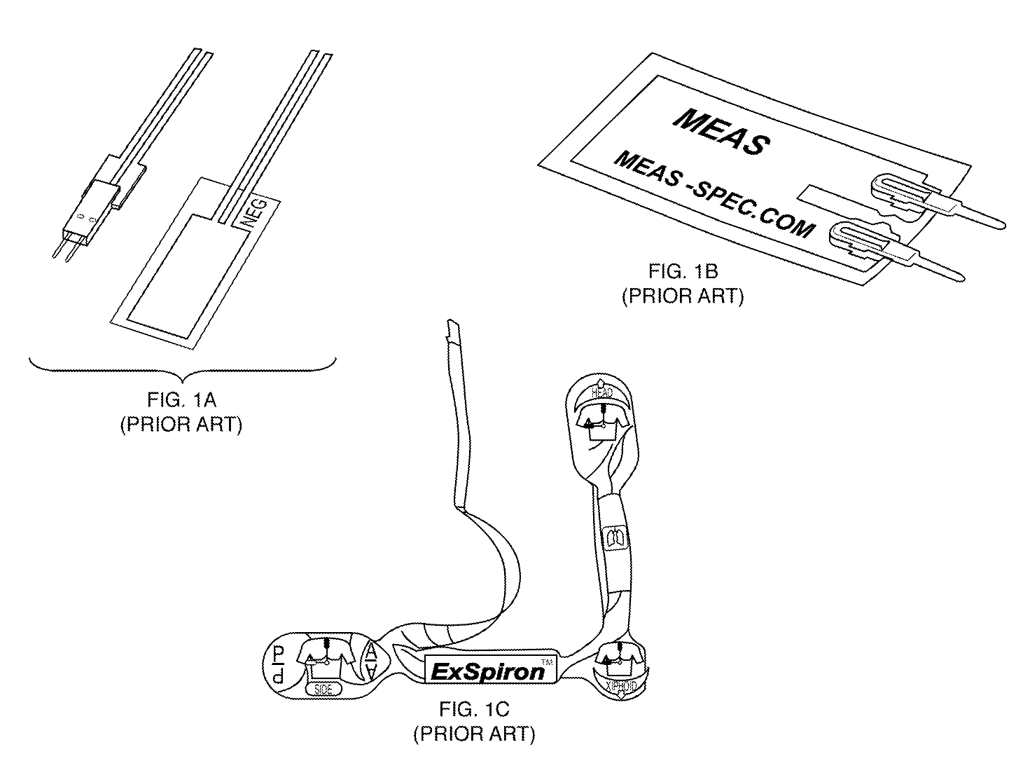

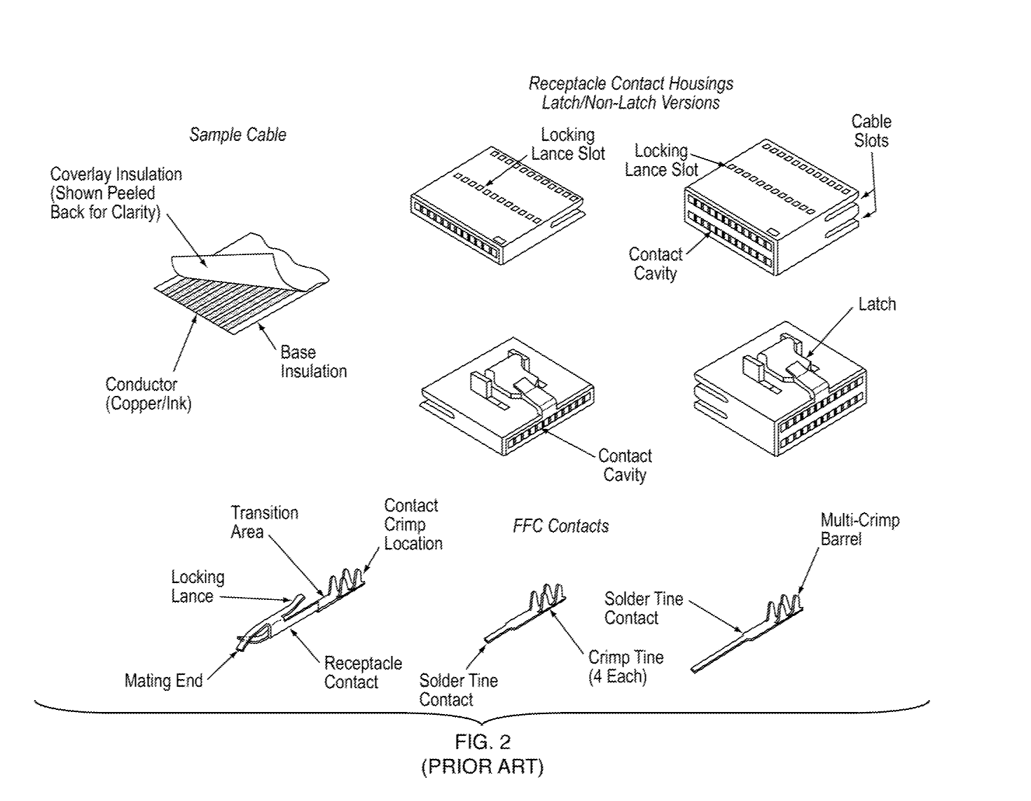

Current interconnection technology for conductive ink circuits often involves crimping formed metal contacts to the conductors and then inserting those contacts into a molded plastic housing. See, for example, FIG. 1 and FIG. 2. AMPMODU is an interconnection system product line offered by the company TE Connectivity. This product line includes a sub-category of connectors that use formed contacts that can be crimped to flat flexible cable (EEG) or flexible printed circuits (EEC) and then inserted into a plastic housing to form one half of an interconnection system. These interconnection systems are typically only rated for up to 200 mating cycles with many only being rated for 25 to 50 cycles. See, for example, Table 1.

TABLE 1
Performance Specifications

| | Board-re-Board. | Board-to-Board. | Cable-to-Board, | Cableto-Bmed, |
|---|---|---|---|---|
| | Thru-Hole | Sullow-Mount. | .050 271 | . [symbol] 22 10.0a] |
| | liaedera and | Header and | Centerline FFC | Centerline Ribbon |
| Description | Reempiaclee | Pecepreclee | Cable Receptacle! | Cable Receptacle* |
| Sae [symbol] 311gc-Er01.7 [symbol] | 4 thou 50 | | 4 thrh 50 | |
| [symbol] Row | 10 thru [symbol] | 10 [symbol] 100 | [symbol] dvti 150 | to [symbol] lt |
| Currant Poling Lee [symbol] own | 1 [symbol] 0 amperes | 1 [symbol] 0 amperes | 1 [symbol] 5 angler! | 0.5 ampere |
| Coeleclat Wilhatoxlog Voltage | 500 VAC | 500 VAC | 2 [symbol] VAC | 200 VAC |
| Insullaion Fragisaince | 5,000 Megehms | 2,000 Megotene | 5,000 Magcaime | 5,050 Alegohmi |
| Drzabity (Waled to) | 200 Cycles | 200 Cycles | 205 Cycles | 150 Cycles |
| Haim Fame (per mead) | oz. 11.20N] Wm | 5 oz. [1.36N] FAIN | 2 oz. [2.22N] M. | 4 oz. [1.1 IV] Mal |
| [symbol] ing Force (per ecols [symbol] | oz. 10 22 141 | e oz. [0.22N] Mn | 1 err_ 10 27 Mir % | [symbol] 0.5 oz Met |
| Operating Termerehre | −05° C. lo + 105° C. | − [symbol] ° C. o [symbol] 105° C. | −55° C. 113 g5 C. | −05° C. lo + 105° C. |

*WM [symbol] oam deplesed [symbol]
indicates data missing or illegible when filed

Other interconnection methods involve directly attaching a wire harness or circuit board to the sensor using conductive adhesive or epoxy. In either case, manufacturing of the sensor involves adding the cost of the crimped contact and housing to the disposable portion of the system, which can, in some cases, exceed the cost of the sensor itself.

Another current interconnection technology includes ZIP (Zero Insertion Force) or LIF (Low Insertion Force) connectors. These connectors are designed for use with copper conductors. The contacts in ZIF and LIF connectors damage the printed ink conductors of the sensor due to scraping or piercing of the contact and, as such, do not create a reliable interconnect. The act of mating the cable and connector has a tendency to transfer conductive ink to the contacts of the connector, which can build up inside the connector causing electrical shorts. ZIF and LIF connectors are also very limited in durability since they are designed for only a few mating cycles.

The rolling element of the present invention eliminates the need to crimp contacts onto the sensor thereby reducing the overall sensor cost while at the same time significantly increasing the number of mating cycles of the mating connector. The rolling element of the present invention also improves the reliability of the interconnection system by eliminating damage to the conductive ink circuit, transfer of ink to the contact, and wear due to vibration.

The rolling element of the present invention reduces material cost of the disposable portion of the interconnect which is used in the highest volume, thus saving considerable resources. In addition, the rolling element of the present invention reduces assembly labor on the disposable portion of the interconnect.

The increased reliability due to the elimination of wear and damage to the conductive ink traces during mating cycle is another benefit of the rolling element of the present invention. The increased reliability of the interconnection system of the present invention is also due to the rolling element, which mitigates wear and damage due to handling and vibration.

One feature of the rolling element of the present invention is improved handling and ease of use. The interconnection system of the present invention is designed for use in the medical environment, and is not simply adapted from industrial applications. The ruggedized design also helps to prevent damage due to misuse.

One embodiment of the present invention comprises of a spring-loaded contact system employing a rolling element, which is preferably spherical in nature but could be cylindrical, and the like. In certain embodiments, the rolling element serves as the interface between a spring-loaded contact and a multi-conductor circuit, which can be a printed conductive ink circuit, flexible printed circuit, printed circuit board, or other device similar in nature. In one embodiment of the present invention, the spring-loaded contact provides a minimum contact force suitable for a reliable electrical interconnection. The minimum contact force is dependent on the substrate, conductive material, and/or plating used to construct the circuit. In certain embodiments, the rolling element allows an electrical interconnection to be made to the circuit, which does not pierce, scrape, or otherwise damage the circuit during the insertion/extraction (mating) cycle or during normal use.

The “spring-loaded” contact of the present invention may be constructed of a metallic material, which preferably has both a high electrical conductivity and a high flexibility such as copper or its alloys (brass, bronze, beryllium copper, etc.). In certain embodiments, the spring-loaded contact may be constructed of a non-conductive material comprising an electrically conductive coating, or the like. As the single or multi-conductor circuit is mated with the spring-loaded contact, the circuit applies pressure to the rolling element, which in turn causes the arm of the spring-loaded contact to deflect within its elastic range. When the single or multi-conductor circuit is fully engaged with the spring-loaded contact, the arm reaches its peak deflection and due to the elasticity of the material, generates a spring force, which provides the minimum contact force required for a reliable electrical connection throughout the duration of the mating cycle. Said minimum contact force being dependent on the conductive materials and metallic plating(s) being used and which are known to those skilled in the art. In certain embodiments, the minimum contact force is about 30 grams force for gold to gold connections, the minimum contact force is about 150 grams force for tin to tin connections, and the like.

In certain embodiments of the present invention, the system further comprises an electrically insulated housing for positioning and retaining the contact system. In certain embodiments, the system further comprises features such as a keyed opening, guiding surfaces, and retention springs (locking elements) for aligning to and retaining the circuit once engaged. In certain embodiments, the rolling element may be retained by the spring-loaded contact, by the electrically insulated housing, or by other mechanisms known to those of skill in the art.

In one embodiment of the present invention, as the circuit is inserted into the connector, the rolling element rolls along the surface of the conductor until the circuit is fully engaged, at which point the circuit is retained by the connector. Once fully engaged, any relative movement between the circuit and the connector, which may be due to handling or vibration, is absorbed by the rolling element, which is allowed to roll over the conductor surface thereby preventing damage to the circuit due to scraping or frictional wear, and produces a more reliable interconnect.

In certain embodiments, the tail end of the contact may be constructed in a variety of ways including, but not limited to, soldering to plated through-holes or pads of a printed circuit board, soldering or crimping to solid or stranded core wire, and other mechanisms known to those of skill in the art.

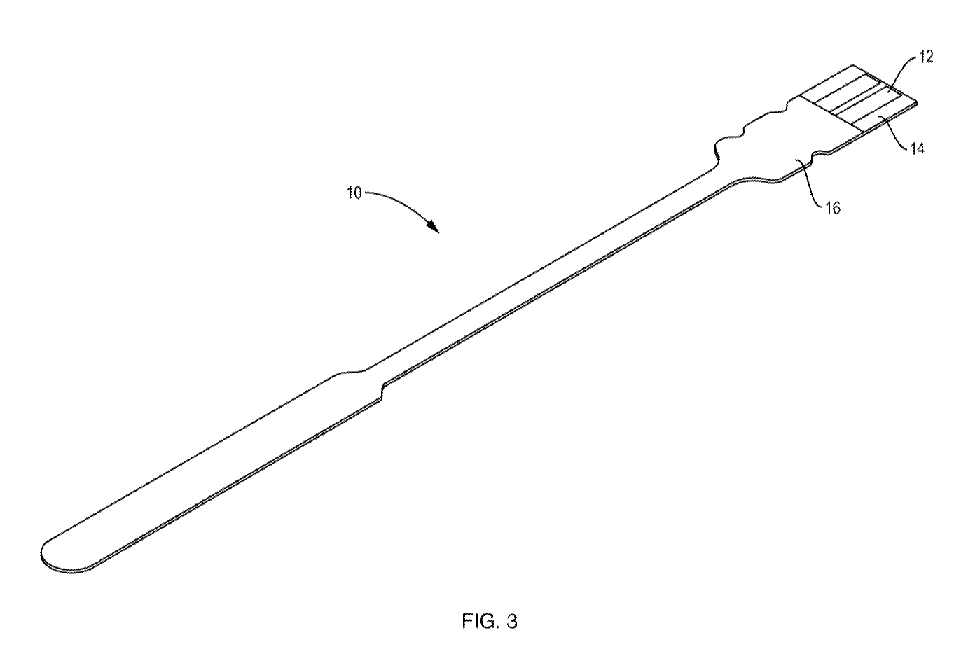

Referring to FIG. 3, one embodiment of a multi-conductor circuit 10 of the present invention is shown. More particularly, one illustrative embodiment of the multi-conductor circuit of the present invention comprises a substrate 14 with two conductive printed regions 12. Additionally, in certain embodiments, the substrate is contoured 16 to aid in the alignment and retention of the multi-conductor circuit in an electrically insulating housing (not shown).

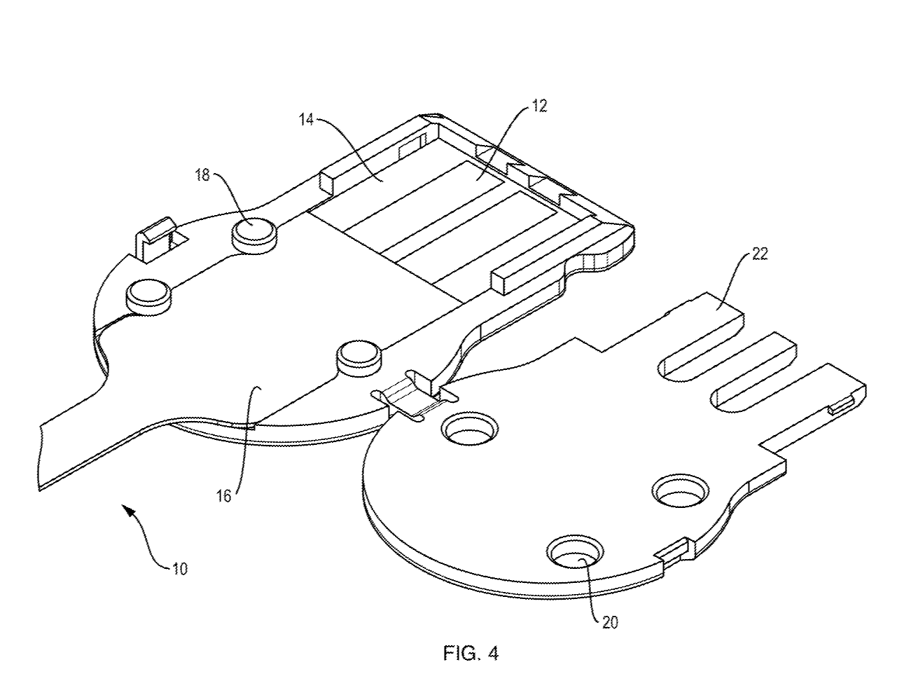

Referring to FIG. 4, one embodiment of a housing of the present invention is shown in an open configuration. The housing is used to retain a multi-conductor circuit. More particularly, an illustrative embodiment of the multi-conductor circuit of the present invention comprises a substrate 14 with two conductive printed regions 12. In certain embodiments, the substrate is contoured 16 to aid in the alignment and retention of the multi-conductor circuit to match contours 18 on the electrically insulated housing 22 in certain embodiments, the housing is formed as a single unit. In certain embodiments, the housing is formed as separate units that are “snapped” together (e.g. 18 and 20) to form a housing that encases the multi-conductor circuit. It is understood that the housing could be constructed using methods well known to those of skill in the art including, but not limited to, mechanical fastening screws), heat staking, ultrasonic welding, molding, potting, or adhesive bonding.

Referring to FIG. S, one embodiment of a housing of the present invention is shown in a dosed configuration. The housing is used to retain a multi conductor circuit. More particularly, an illustrative embodiment of the multi-conductor circuit of the present invention comprises two conductive printed regions 12. The housing 22 comprises “notches” 28 that expose the conductive circuit 12. In certain embodiments, the housing comprises contours 24 for mating with the spring-loaded locking elements of the present invention. In certain embodiments, the housing comprises “grip” contours for improved ease of use 26.

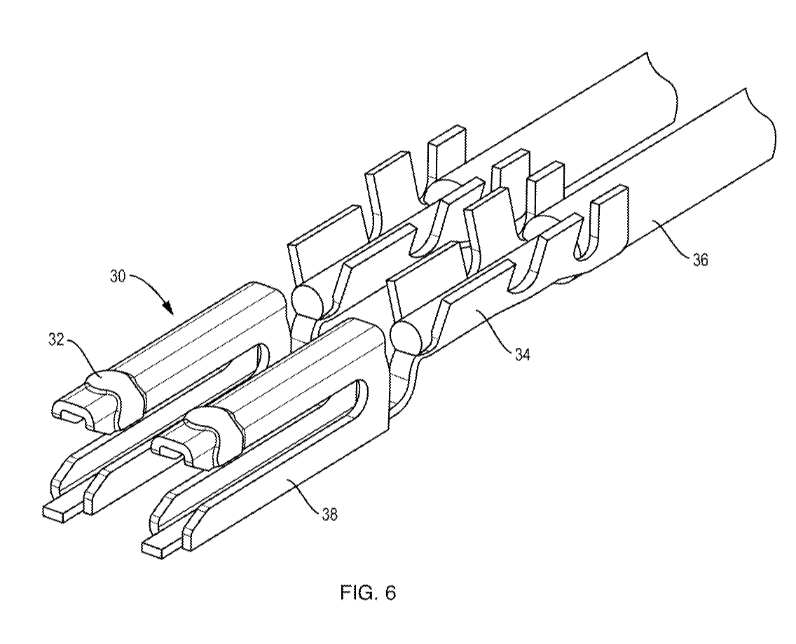

Referring to FIG. 6, one embodiment of a spring-loaded contact of the present invention comprising a rolling element is shown. More particularly, a spring-loaded contact 30 is shown attached to wires 36 using crimps 34 and comprising a rolling element 32. In certain embodiments of the present invention, the rolling element 32 is spherical. In certain embodiments, the rolling element is cylindrical. In certain embodiments, the rolling element is retained by the body of the spring-loaded contact 38. In certain embodiments of the present invention, the rolling element is in electrical contact with the spring-loaded contact.

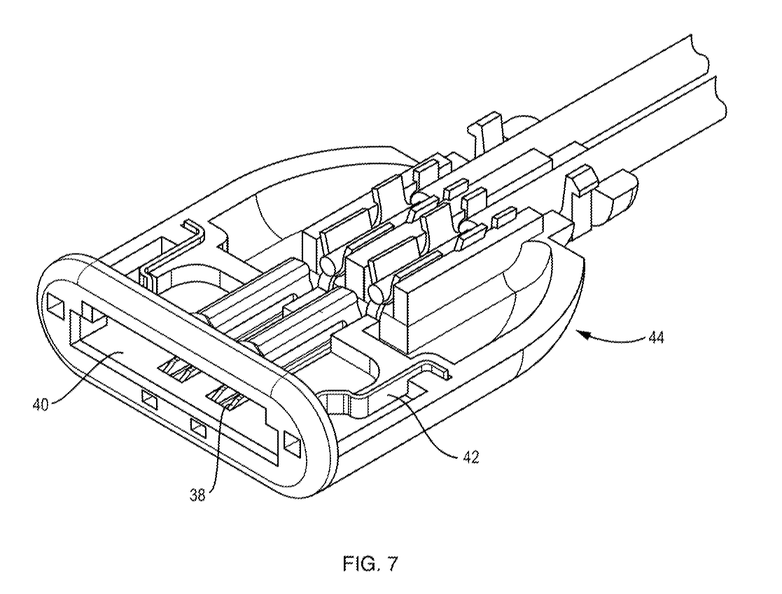

Referring to FIG. 7, one embodiment of a housing of the present invention is shown in an open configuration. The housing is used to retain a spring-loaded contact of the present invention comprising a rolling element. More particularly, a housing 44 is shown in cut away with a spring-loaded contact 38 inserted in the housing. The spring-loaded element comprises a rolling element 32. In certain embodiments, locking elements 42 help to anchor the multi-conductor circuit into the housing 44 when mated with the spring-loaded contact. In certain embodiments of the present invention the housing 44 comprises a receiving area 40 to receive a housing used to retain a multi conductor circuit of the present invention. In certain embodiments, the housing 44 comprises a receiving area to receive a multi-conductor circuit directly (e.g., without a housing).

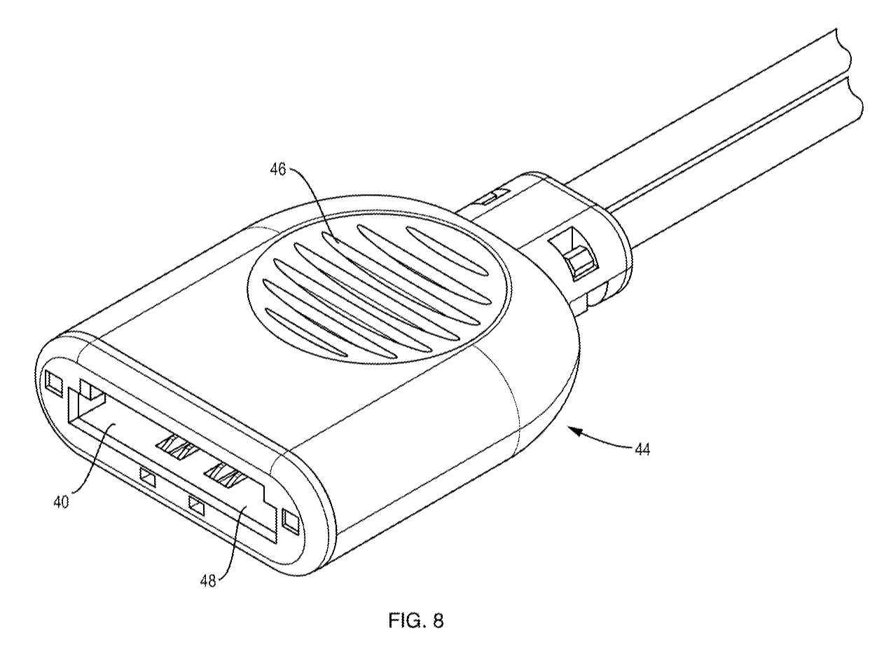

Referring to FIG. 8, one embodiment of a housing of the present invention is shown in a closed configuration. The housing is used to retain a spring-loaded contact of the present invention comprising a rolling element. More particularly, a housing 44 is shown with the spring-loaded contact comprising a roiling element. In certain embodiments of the present invention the housing 44 comprises a receiving area 40 to receive a multi conductor circuit. In certain embodiments, the housing 44 comprises “notches” 48 that expose the spring-loaded contact and rolling element to allow for electrical connection with a multi-conductor circuit. In certain embodiments, the housing 44 is formed as a single unit. In certain embodiments, the housing 44 is formed as separate units that are “snapped” together to form a housing that encases the spring-loaded contact comprising the rolling element of the present invention. In certain embodiments, the housing comprises “grip” contours for improved ease of use 46. It is understood that the housing could be constructed using methods well known to those of skill in the art including, but not limited to, mechanical fastening (screws), heat staking, ultrasonic welding, molding, potting, or adhesive bonding.

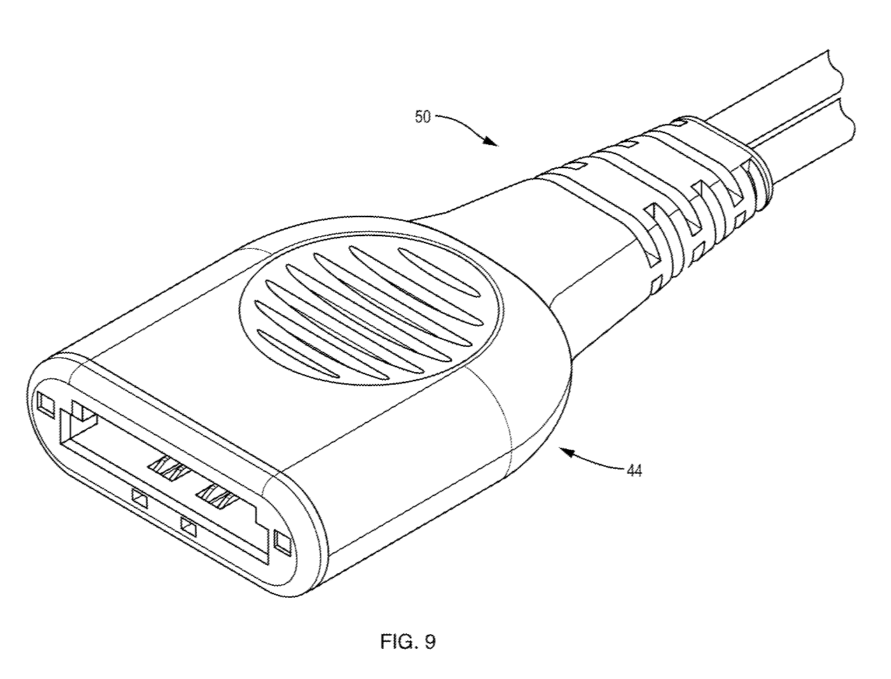

Referring to FIG. 9, one embodiment of a housing of the present invention is shown with external molded wire protectors 50 to provide strain relief. In certain embodiments, the wire strain relief 50 may be internal to the housing 44. In certain embodiments, the strain relief may take the form of a clamp or other device known to those of skill in the art. The housing is in a closed configuration and is used to retain a spring-loaded contact of the present invention comprising a rolling element.

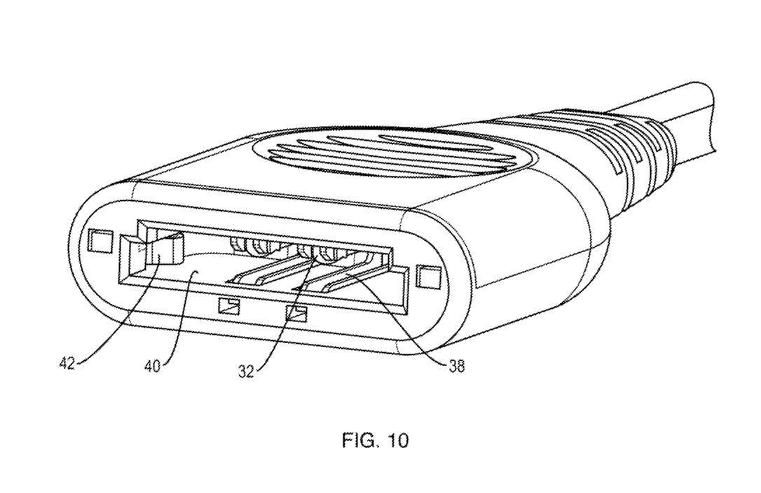

Referring to FIG. 10, a front perspective view of a housing used to retain a spring-loaded contact of the present invention comprising a rolling element is shown. More particularly, the receiving area 40 is shown which exposes the spring-loaded contact 38 of the present invention comprising a rolling element 32. In certain embodiments, a locking element 42 is used to retain a multi-conductor circuit in proper orientation to create a reliable electrical connection. In certain embodiments, the rolling element provides increased reliability due to the elimination of wear and damage to the conductive ink traces during a mating cycle. The increased reliability of the rolling element of the present invention is also due to the elimination of wear and damage due to handling and vibration because the rolling element acts as a “shock absorber.” In other connectors, if the circuit is moved in relationship to the connector (e.g., shock or vibration) the contacts of the connector must therefore move across the conductive surface of the circuit. In a printed ink circuit, this translates to the contact either scraping across the surface of the conductor or through the conductor. In this invention, if the circuit is moved in relationship to the connector (e.g., shock or vibration) the rolling element can roll across the surface of the conductive surface of the circuit, effectively moving with the circuit to prevent damage and thereby “absorbing” said shock or vibration.

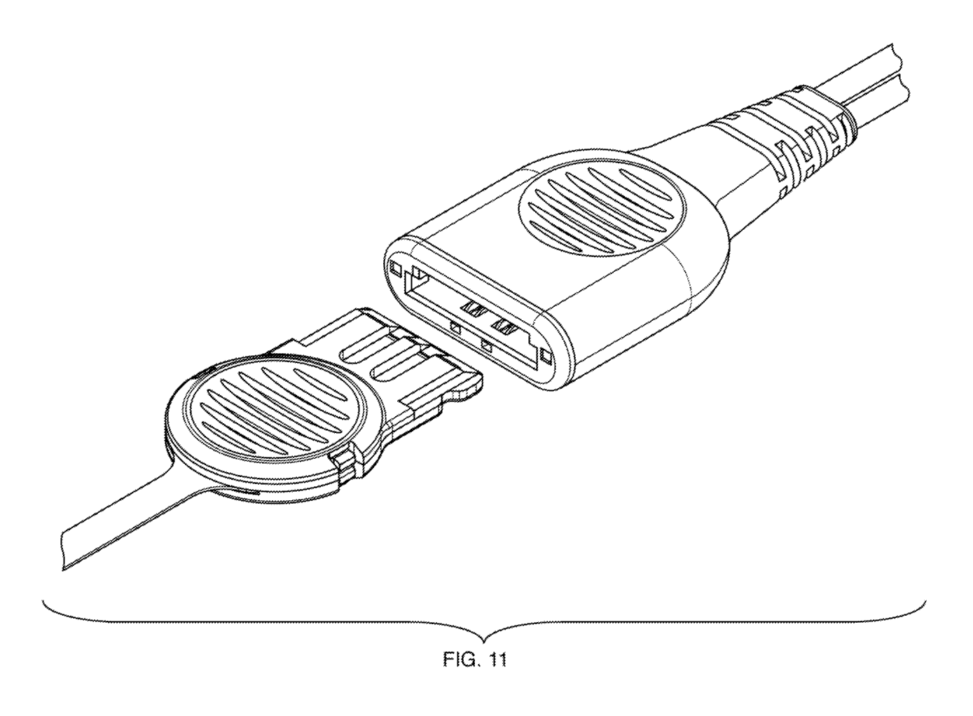

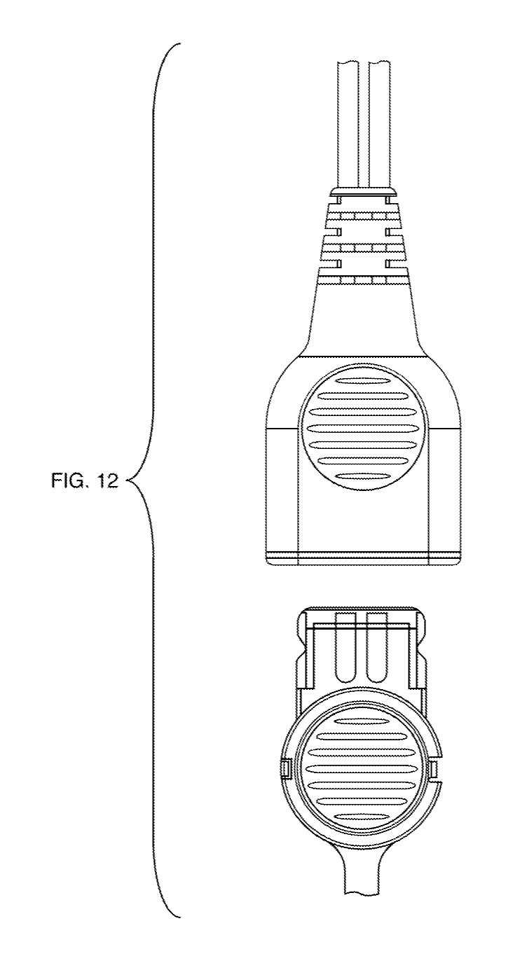

Referring to FIG. 11, a perspective view of certain mateable embodiments of the present invention is shown. In a mating cycle, the multi-conductor ink circuit is inserted into and mated with a spring-loaded contact comprising a rolling element. Here, the multi-conductor circuit is shown with two conductive ink regions. It is understood that many variations on the number of conductive ink regions may be used and that could be equal to the number of rolling elements used to contact the ink circuits. In certain embodiments of the present invention, a single rolling element is constructed to contact multiple traces on a multi-conductor circuit by having adjacent conductive and nonconductive regions located along the length of the rolling contact element (e.g., a cylinder). In this Figure, the multi-conductor circuit is shown in an electrically insulating housing. In certain embodiments, no housing is used. In other embodiments, the housing includes features to align the features in only one orientation (keying) so that the conductive ink traces are aligned with the rolling elements. In certain embodiments, the notches 28 that expose the conductive circuit 12 are used to key the housing 22 into the correct orientation to be mated with the connector housing 44. Referring to FIG. 12, a top view of certain mateable embodiments of the present invention is shown.

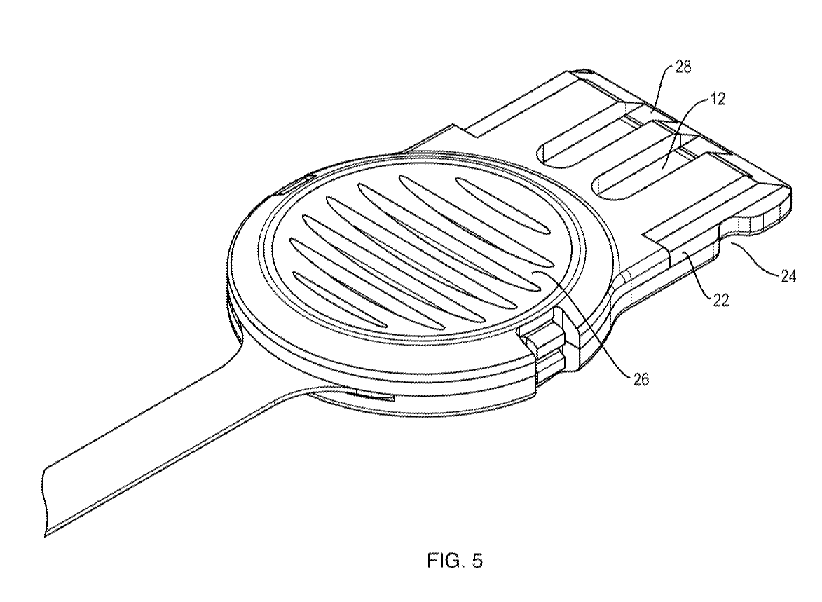

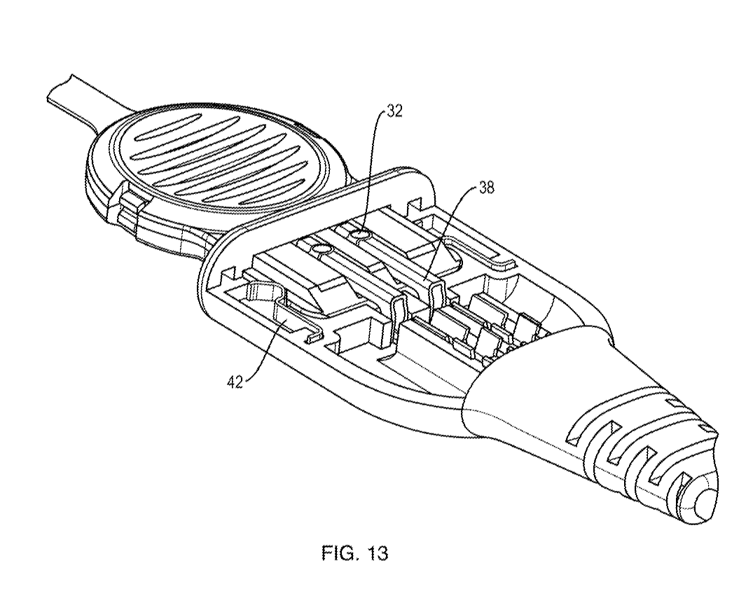

Referring to FIG. 13, a cut-away perspective view of certain embodiments of the present invention that are mated is shown. For illustrative purposes, the embodiments are as shown in FIG. 5 and FIG. 9. More particularly, locking elements 42 are used to anchor and position the multi-conductor circuit in electrical contact with the spring-loaded contact 38 comprising rolling elements 32 during a mating cycle.

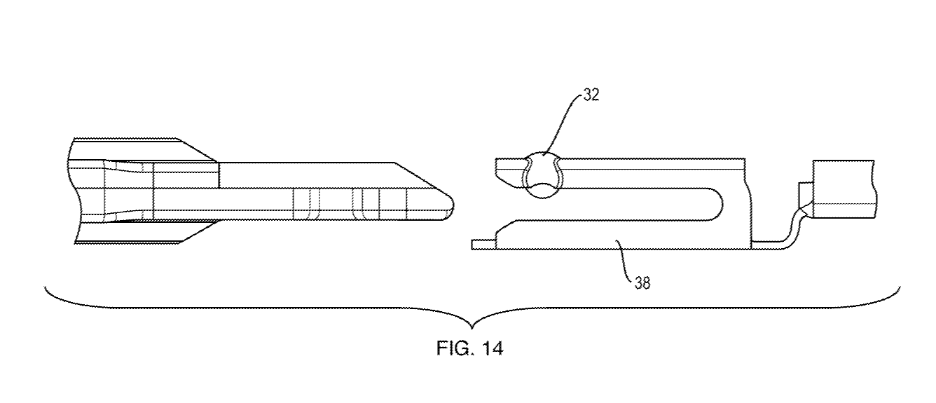

Referring to FIG. 14, a deconstructed view of a conductive element and a spring-loaded contact of the present invention comprising a rolling element is shown. More particularly, the housing containing the circuit is shown to be configured to fit into the spring-loaded contact 38 comprising rolling elements 32 in such a way as to provide a snug fit and to allow the rolling element to act as a “shock absorber.” The rolling element is constructed to roll over the ink circuit to provide a reliable electrical contact without scraping or marring the printed ink region. In certain embodiments, the rolling element is spherical. In certain embodiments, the rolling element is cylindrical. In certain embodiments, the rolling element is retained by the spring-loaded contact. In certain embodiments, the rolling element is in electrical contact with the spring-loaded contact. In certain embodiments, the rolling element is retained by the housing.

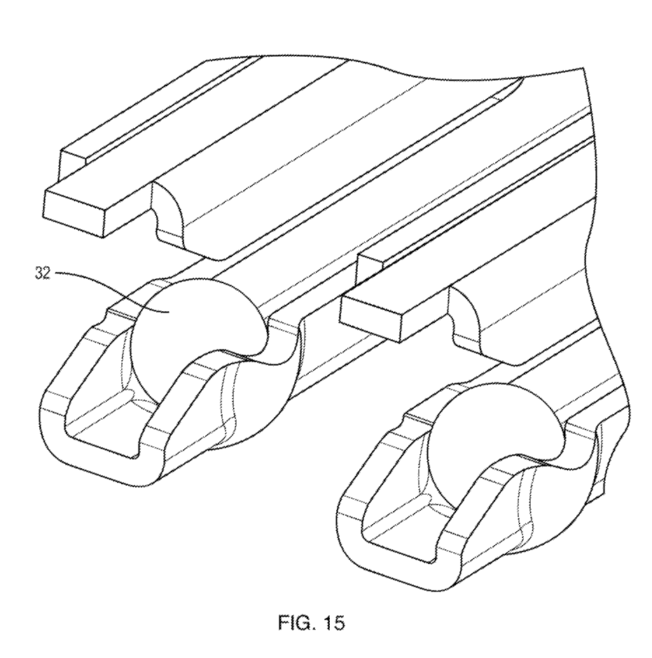

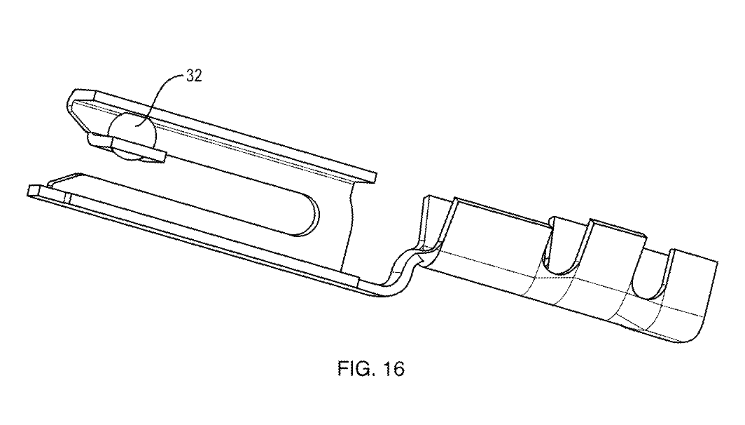

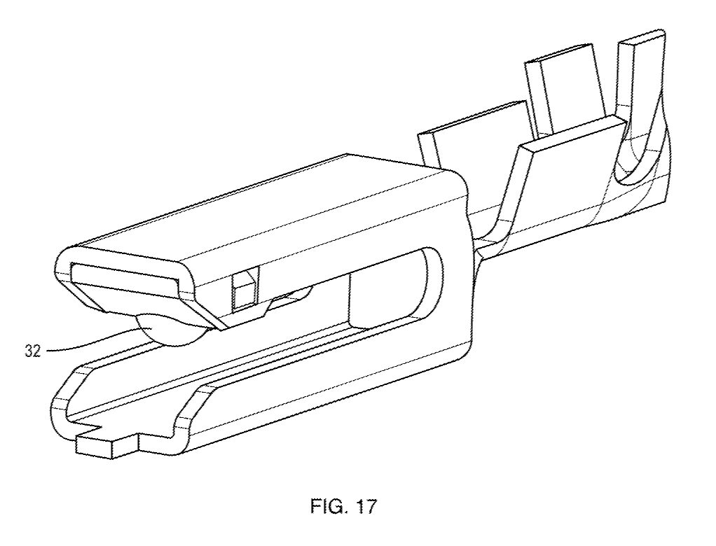

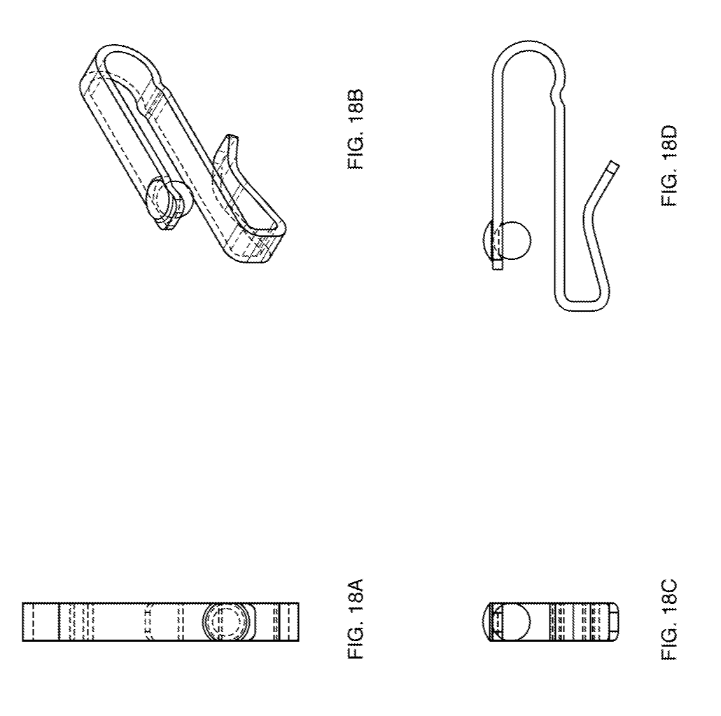

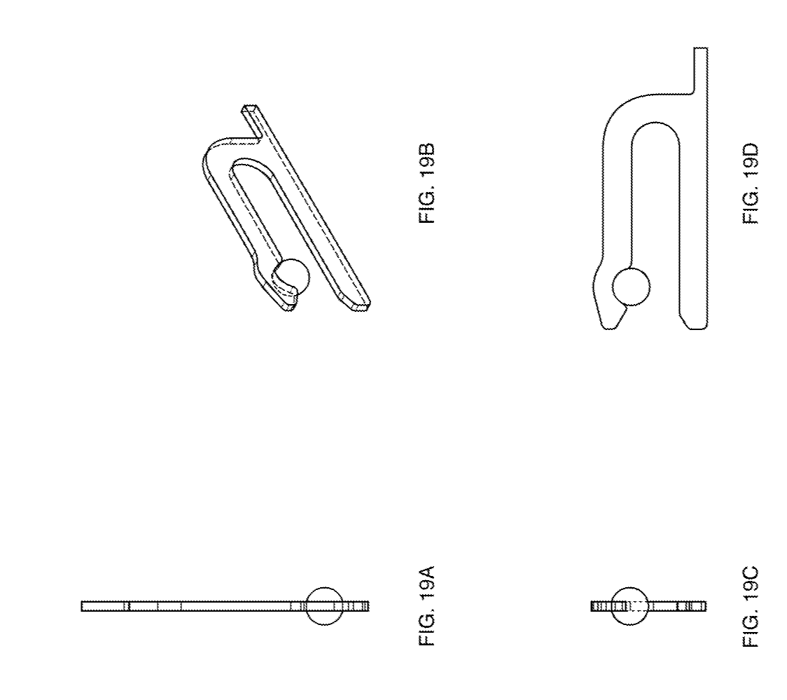

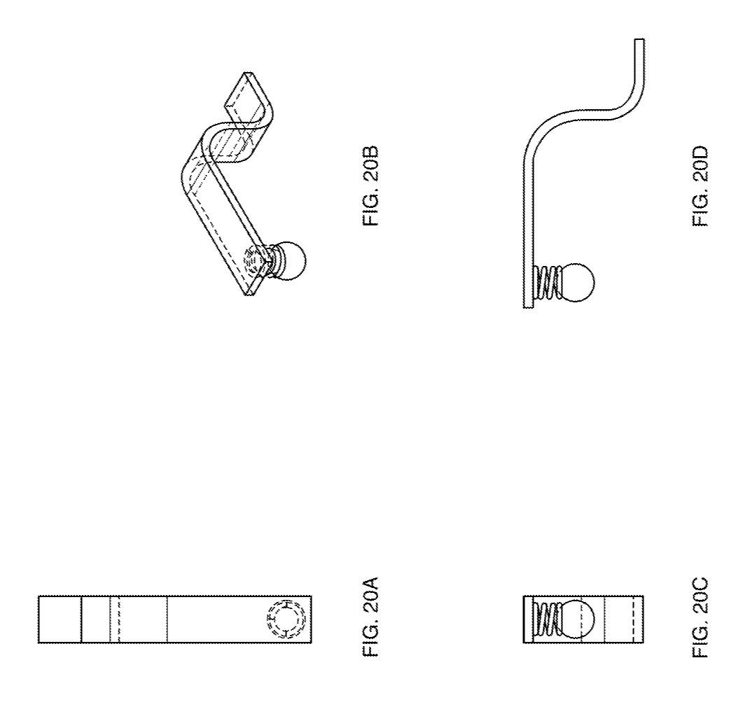

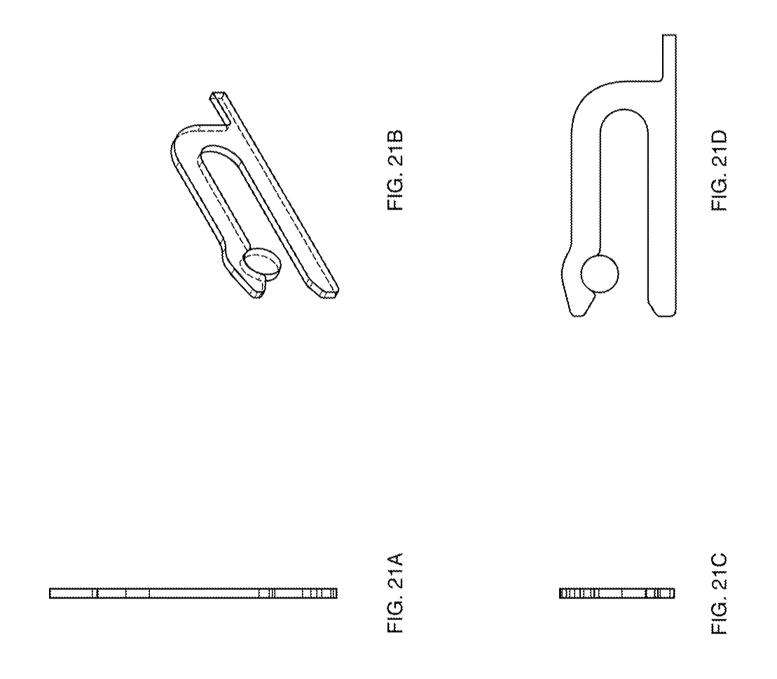

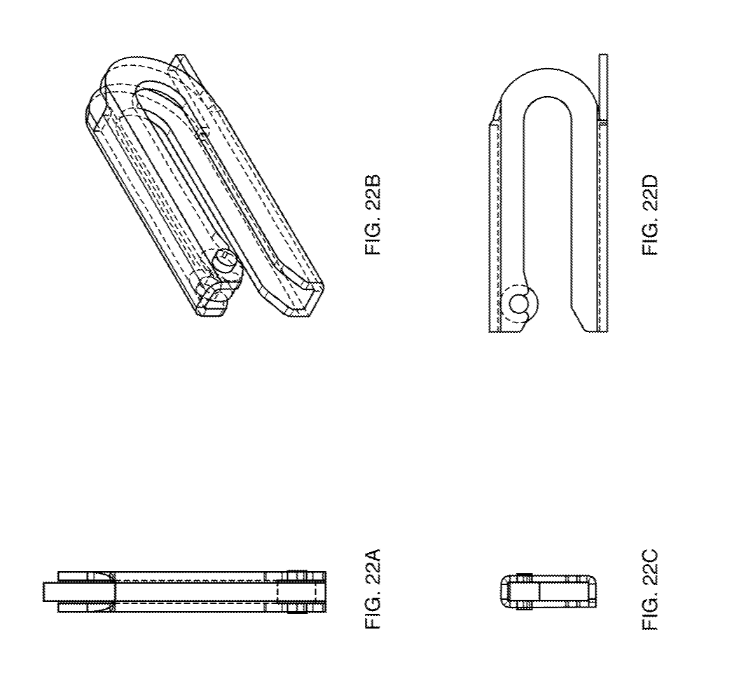

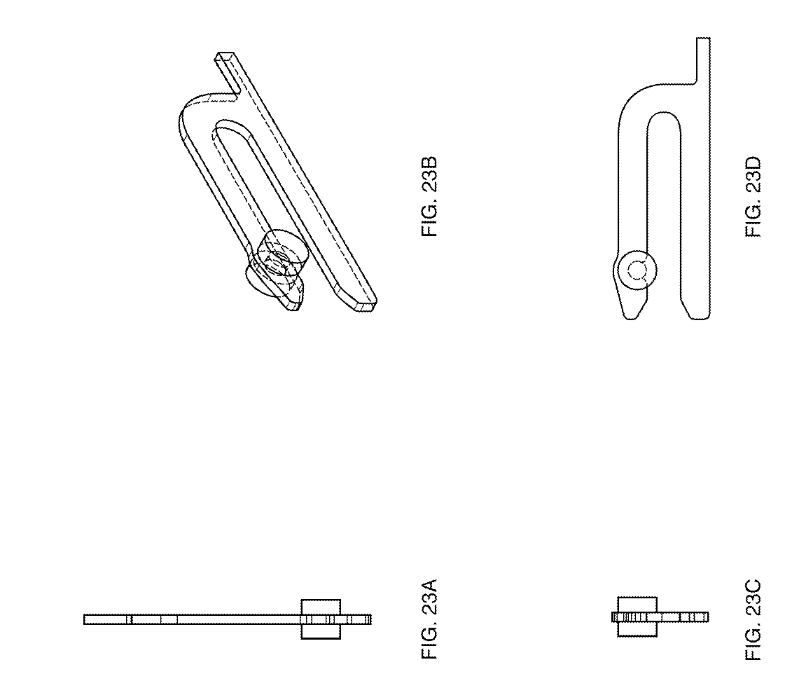

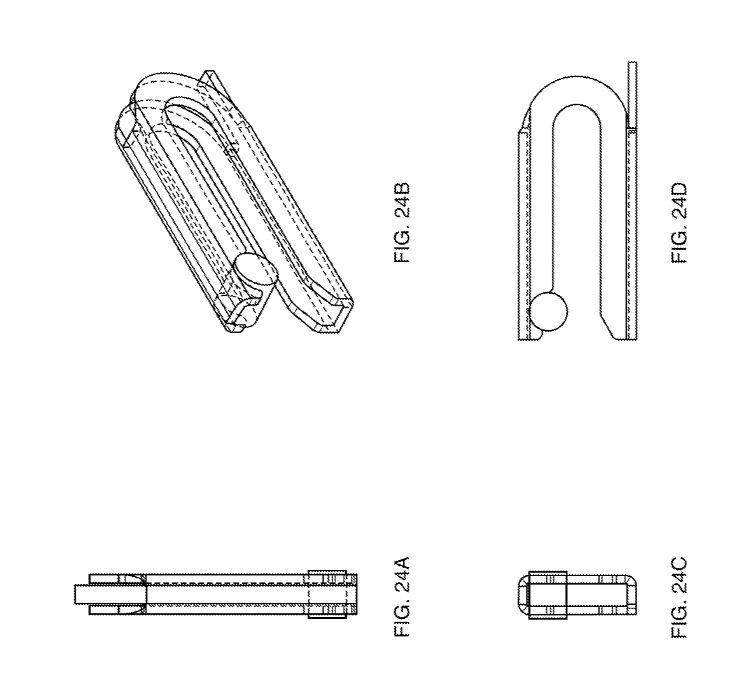

Referring to FIGS. 15-24D, several embodiments of a spring-loaded contact comprising a rolling element of the present invention are shown. In certain embodiments, the rolling element is spherical. In certain embodiments, the rolling element is cylindrical. In certain embodiments, there are one or more rolling elements. In certain embodiments, multiple rolling elements may be used to create a double-ended female connector (not shown).

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention.

What is claimed:

1. An electrical interconnection system, comprising
a. spring-loaded contact comprising an electrically conductive material; and
one or more conductive rolling elements.

2. The electrical interconnection system of claim 1, wherein there are two or more conductive rolling elements.

3. The electrical interconnection system of claim 2, wherein the two or more conductive roiling elements are positioned to create a double-ended female connector.

4. The electrical interconnection system of claim 1, wherein the one or more conductive rolling elements are cylindrical.

5. The electrical interconnection system of claim wherein the one or more conductive rolling elements are spherical.

6. The electrical interconnection system of claim 1, wherein the one or more conductive roiling elements are retained by the spring-loaded contact.

7. The electrical interconnection system of claim 1, wherein the one or more conductive rolling elements are in electrical contact with the spring-loaded contact.

8. The electrical interconnection system of claim 1, further comprising an electrically insulated housing retaining one or more electrically conductive spring-loaded contacts comprising one or more conductive rolling elements.

9. The electrical interconnection system of claim 1, further comprising a single or multi-conductor circuit.

10. The electrical interconnection system of claim 8, wherein the electrically insulated housing positions a single or multi-conductor circuit in electrical contact with the one or more electrically conductive spring-loaded contacts comprising one Or more conductive rolling elements during a mating cycle.

11. The electrical interconnection system of claim 8, wherein the electrically insulated housing further comprises a friction lock to retain a single or multi-conductor circuit in electrical contact with the one or more electrically conductive spring-loaded contacts comprising one or more conductive rolling elements during a mating cycle.

12. The electrical interconnection system of claim 11, wherein the friction lock is comprised of spring loaded locking elements comprising rolling elements.

13. The electrical interconnection system of claim 8, wherein the electrically insulated housing further comprises a releasable mechanical lock to retain a single or multi-conductor circuit in electrical contact with the one or more electrically conductive spring-loaded contacts comprising one or more conductive rolling elements during a mating cycle.

14. The electrical interconnection system of claim 8, further comprising an electrically insulated housing retaining a single or multi-conductor circuit that is mateable with the electrically insulated housing retaining the one or more electrically conductive spring-loaded contacts comprising one or more conductive rolling elements.

15. A method of manufacturing an electrical interconnection system comprising one or more spring-loaded contacts and one or more conductive rolling elements, comprising
providing one or more conductive rolling elements;
providing one or more spring loaded contacts; and
contacting the one or more conductive rolling elements with the one or more spring-loaded contacts.

16. The method of manufacturing an electrical interconnection system comprising a spring-loaded contact and a conductive rolling element of claim 15, wherein the step of contacting comprises retaining the rolling element in the spring-loaded contact.

17. The method of manufacturing an electrical interconnection system comprising a spring-loaded contact and a conductive rolling element of claim 15, wherein the step of contacting comprises retaining the rolling element in the housing.

18. The method of manufacturing an electrical interconnection system comprising a spring-loaded contact and a conductive rolling element of claim 15 wherein the spring-loaded contact is stamped, formed, etched, or coined to retain the conductive rolling element.
